(19) United States
(12) Patent Application Publication
(10) Pub. No.: US 2017/0270592 A1
(43) Pub. Date: Sep. 21, 2017

(54) CONTROL APPARATUS FOR MAN-MACHINE INTERACTION USING RECEPTOR AND EFFECTOR, METHOD, AND NON-TRANSITORY COMPUTER READABLE STORAGE MEDIUM

(71) Applicant: YAHOO JAPAN CORPORATION, Tokyo (JP)

(72) Inventors: Yoshihiro OSADA, Tokyo (JP); Asuka NOGAMI, Tokyo (JP)

(73) Assignee: YAHOO JAPAN CORPORATION, Tokyo (JP)

(21) Appl. No.: 15/450,615

(22) Filed: Mar. 6, 2017

(30) Foreign Application Priority Data
Mar. 17, 2016 (JP) 2016-054359

(51) Int. Cl. G06Q 30/06; G06N 5/04

(52) U.S. Cl. CPC G06Q 30/0631; G06N 5/04

(57) ABSTRACT

A control apparatus for a man-machine interaction according to the present application includes a first processing unit and a second processing unit. The first processing unit acquires detection information detected using a sensor as a receptor by an artifact including an interface configured to perform a man-machine conversational interaction with a user, using the sensor and an effector as an output apparatus, the detection information indicating a status of the interaction. The second processing unit, based on the detection information acquired by the first processing unit, controls the interaction by an electronic information processing apparatus including a storage apparatus by controlling at least one of reading and writing from and to data stored in the storage apparatus and processing on the data and the output apparatus.

### CROSS-REFERENCE TO RELATED APPLICATION(S)

The present application claims priority to and incorporates by reference the entire contents of Japanese Patent Application No. 2016-054359 filed in Japan on Mar. 17, 2016.

### BACKGROUND OF THE INVENTION

1. Field of the Invention

The present invention relates to a control apparatus for a man-machine interaction using a receptor and an effector, a method, and a non-transitory computer readable storage medium having stored therein a computer program.

2. Description of the Related Art

Electronic commerce that sells a product via the Internet has been known in recent years. A technique that recommends a product to a user has been known as a technique relating to such electronic commerce. For example, such a technique outputs a conversation relating to a product on the basis of a result of analyzing the subject matter of a conversation input by the user.

However, the aforementioned conventional technique has not necessarily been able to support the purchase of a product. For example, the aforementioned conventional technique extracts a feature quantity that assesses a state of the user on the basis of a result of analyzing the subject matter of a conversation input by the user and then dynamically controls a flow of a conversation by inferring the subject matter of a conversation to be output on the basis of the extracted feature quantity. For such a reason, the aforementioned conventional technique has not necessarily been able to support the purchase of a product since the product is recommended in real time during the direct conversation with the user.

### SUMMARY OF THE INVENTION

It is an object of the present invention to at least partially solve the problems in the conventional technology.

A control apparatus for a man-machine interaction according to the present application includes a first processing unit that acquires detection information detected using a sensor as a receptor by an artifact including an interface configured to perform a man-machine conversational interaction with a user, using the sensor and an effector as an output apparatus, the detection information indicating a status of the interaction, and a second processing unit that, based on the detection information acquired by the first processing unit, controls the interaction by an electronic information processing apparatus including a storage apparatus by controlling at least one of reading and writing from and to data stored in the storage apparatus and processing on the data and the output apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an example of recommendation processing by a purchase support system according to a first embodiment;

FIG. 2 is a diagram illustrating an exemplary configuration of the purchase support system according to the first embodiment;

FIG. 3 is a diagram illustrating an exemplary configuration of a delivery apparatus according to the first embodiment;

FIG. 4 is a diagram illustrating an example of a user information storage unit according to the first embodiment;

FIG. 5 is a diagram illustrating an example of a detection information storage unit according to the first embodiment;

FIG. 6 is a diagram illustrating an example of a content information storage unit according to the first embodiment;

FIG. 7 is a sequence illustrating recommendation processing procedures by the purchase support system according to the first embodiment;

FIG. 8 is an explanatory diagram illustrating an example of explanation processing by a purchase support system according to a second embodiment;

FIG. 9 is a diagram illustrating an exemplary configuration of a delivery apparatus according to the second embodiment;

FIG. 10 is a sequence illustrating explanation processing procedures by the purchase support system according to the second embodiment; and

FIG. 11 is a hardware configuration diagram illustrating an example of a computer that realizes a function of the delivery apparatus.

### DETAILED DESCRIPTION OF THE PREFERRED EMBODIMENTS

Hereinafter, modes for carrying out a CONTROL APPARATUS FOR MAN-MACHINE INTERACTION USING RECEPTOR AND EFFECTOR, a method, and a COMPUTER program according to the present application (hereinafter, referred to as “embodiments”) will be described in detail with reference to the drawings. These embodiments should not be construed to limit the CONTROL APPARATUS FOR MAN-MACHINE INTERACTION USING RECEPTOR AND EFFECTOR, the method, and the COMPUTER program according to the present application. In the embodiments below, the same constituent members are denoted with the same reference numerals and the duplicated description will be omitted.

### 1. First Embodiment

### 1-1. Recommendation Processing According to First Embodiment

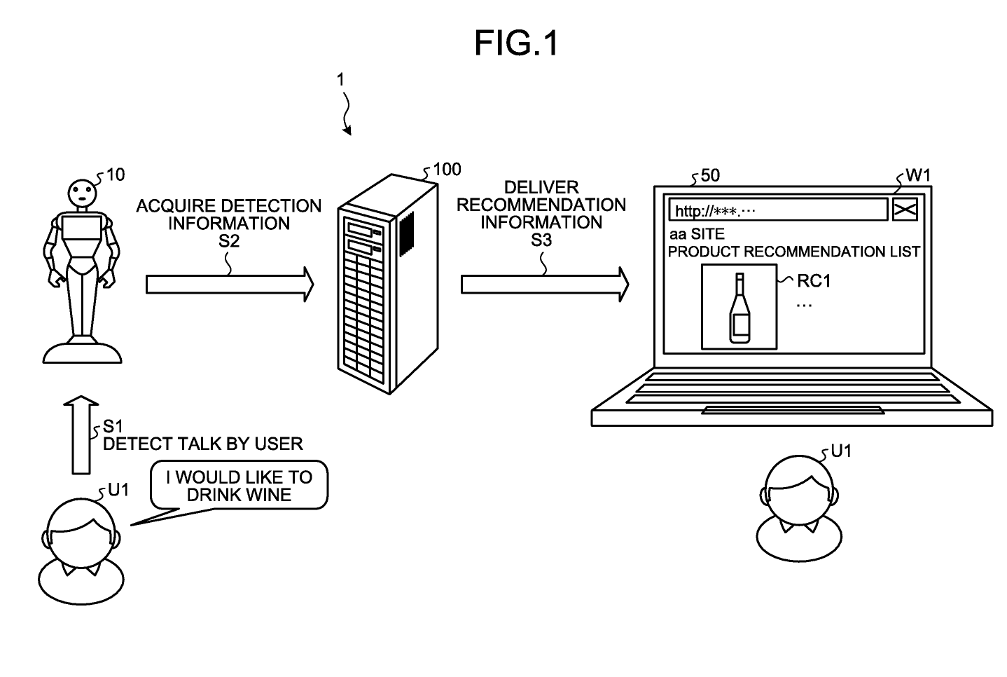

First, an example of recommendation processing according to a first embodiment will be described with reference to FIG. 1. FIG. 1 is an explanatory diagram illustrating an example of the recommendation processing by a purchase support system 1 according to the first embodiment. In the example in FIG. 1, the recommendation processing is carried out in which a delivery apparatus 100 (corresponding to an example of the purchase support system 1) recommends a product to a user U1 in an EC site on the basis of detection information detected by an artifact 10.

As illustrated in FIG. 1, the purchase support system 1 includes the artifact 10, a terminal apparatus 50, and the delivery apparatus 100. Each of the artifact 10, the delivery apparatus 100, and the terminal apparatus 50 is connected to a network in a wired or wireless manner so as to be able to communicate.

The artifact 10 is a robot that performs a conversational interaction with a user. Specifically, the artifact 10 recognizes the subject matter of a talk by the user to make a conversation with the user. For example, the artifact 10 is realized by a humanoid robot having a human-like appearance and being capable of recognizing emotions of the user.

The terminal apparatus 50 displays content on a screen. For example, the terminal apparatus 50 transmits a content acquisition request to the delivery apparatus 100 via the network. Thereafter, the terminal apparatus 50 receives the content transmitted as a response to this content acquisition request. Then, the terminal apparatus 50 displays the received content on the screen.

The delivery apparatus 100 delivers the content. For example, upon receiving the content acquisition request via the network, the delivery apparatus 100 delivers the content to a transmission source of this content acquisition request. To give an example, the delivery apparatus 100 delivers recommendation information on a product to be displayed in the EC site to the terminal apparatus 50 as the content.

Specifically, in the purchase support system 1, the artifact 10 detects a talk by the user U1 first (step S1). For example, the artifact 10 detects the subject matter of a spoken statement by the user U1 every time the user U1 makes a spoken statement. To give an example, the artifact 10 detects the subject matter of a spoken statement of “I would like to drink wine” made by the user U1 as a talk by the user U1.

Subsequently, the delivery apparatus 100 acquires the detection information detected by the artifact 10 (step S2). Specifically, as the detection information, the delivery apparatus 100 acquires, from the artifact 10, the subject matter of the spoken statement of “I would like to drink wine” by the user U1.

Then, on the basis of the acquired detection information, the delivery apparatus 100 delivers the recommendation information regarding a recommended product, which recommendation information is to be displayed in the EC site (step S3). Specifically, on the basis of the subject matter of the spoken statement of “I would like to drink wine” by the user U1, the delivery apparatus 100 delivers content RC1 relating to wine as the recommendation information for the user U1. A uniform resource locator (URL) of a page selling wine is incorporated into the content RC1. For example, upon receiving the content acquisition request from the terminal apparatus 50, the delivery apparatus 100 delivers the content RC1 transmitted as a response to this acquisition request to the terminal apparatus 50 used by the user U1. To give an example, the delivery apparatus 100 delivers the content RC1 to the terminal apparatus 50 when the user U1 accesses a web page W1 of the EC site for displaying product recommendations. With this, as illustrated in FIG. 1, the terminal apparatus 50 according to one form displays the content RC1 on the web page W1 of the EC site for displaying product recommendations.

As described above, the purchase support system 1 according to the first embodiment acquires the detection information detected by the artifact 10 that performs the conversational interaction with the user. Additionally, on the basis of the acquired detection information, the purchase support system 1 delivers the recommendation information regarding a recommended product, which recommendation information is to be displayed in the EC site.

As a consequence, the purchase support system 1 can deliver the recommendation information based on the information detected by the artifact 10, thereby being able to support the purchase of a product. For example, the purchase support system 1 can recommend a product on the basis of the subject matter of a talk by the user and thus can recommend a product suitable for the user. In addition, because the purchase support system 1 can recommend a product based on the subject matter of a talk by the user while the user is browsing the EC site, a possibility of the user buying a product can be enhanced. Meanwhile, the purchase support system 1 makes a recommendation in the EC site and accordingly, reduction of willingness to purchase can be deterred compared to a recommendation made during a direct conversation with the artifact 10. Furthermore, sales promotion can be continuously performed since the purchase support system 1 makes a recommendation in the EC site.

Although FIG. 1 has illustrated an example where the purchase support system 1 includes the single artifact 10, the single terminal apparatus 50, and the single delivery apparatus 100, the plurality of artifacts 10, the plurality of terminal apparatuses 50, and the plurality of delivery apparatuses 100 may be included in the purchase support system 1.

Additionally, in order to make the description simple, FIG. 1 has illustrated an example where the subject matter of the partial spoken statement of “I would like to drink wine” is detected as a talk by the user but actually, an entire talk by the user may be detected in addition to the subject matter of this spoken statement.

### 1-2. Configuration of Purchase Support System According to First Embodiment

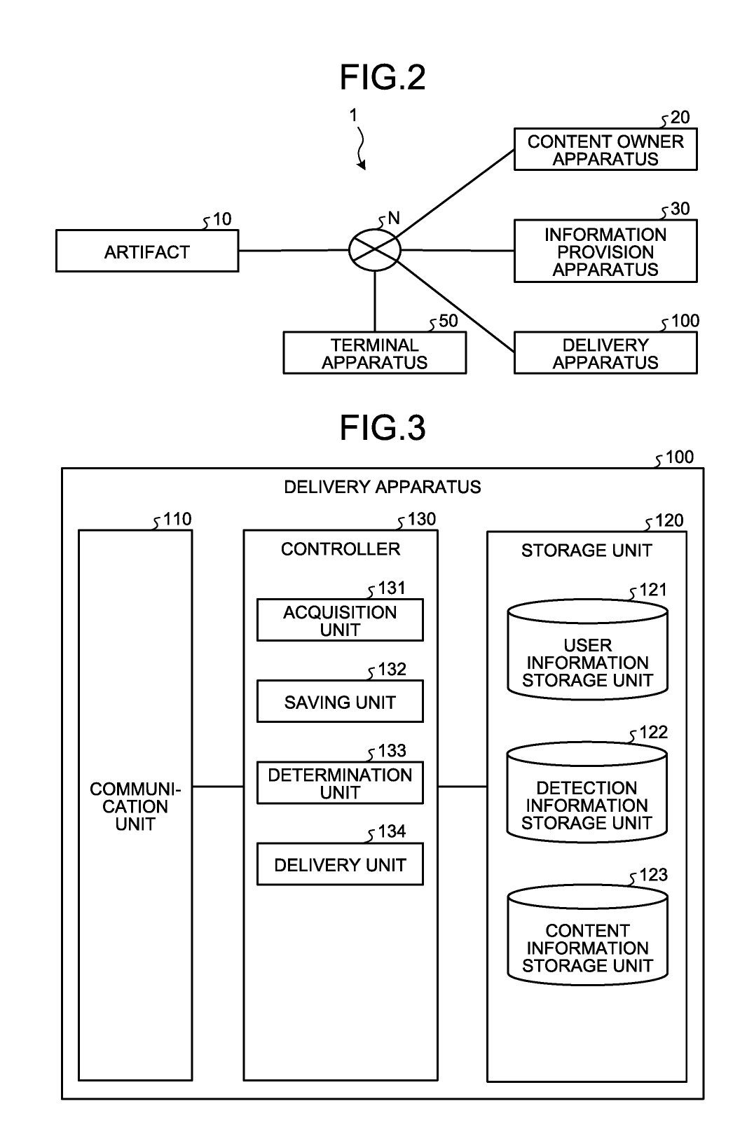

Next, a configuration of the purchase support system 1 according to the first embodiment will be described with reference to FIG. 2. FIG. 2 is a diagram illustrating an exemplary configuration of the purchase support system 1 according to the first embodiment. As illustrated in FIG. 2, the purchase support system 1 includes the artifact 10, a content owner apparatus 20, an information provision apparatus 30, the terminal apparatus 50, and the delivery apparatus 100. The artifact 10, the content owner apparatus 20, the information provision apparatus 30, the terminal apparatus 50, and the delivery apparatus 100 are connected to one another via a network N in a wired or wireless manner so as to be able to communicate. The purchase support system 1 illustrated in FIG. 2 may include the plurality of artifacts 10, the plurality of content owner apparatuses 20, the plurality of information provision apparatuses 30, the plurality of terminal apparatuses 50, and the plurality of delivery apparatuses 100.

The artifact 10 is an information processing apparatus that performs the conversational interaction with the user. Specifically, the artifact 10 has various types of sensors such as a sound sensor, a gyro sensor, a touch sensor, a sonar sensor, a laser sensor, a bumper sensor, an infrared sensor, a temperature sensor, and an illuminance sensor to detect various types of information, including a sound, a distance, an impact, a temperature, humidity, an odor, and brightness. For example, the artifact 10 detects a talk between the user and the artifact 10 and information regarding an environment where the artifact 10 is installed. To give an example, the artifact 10 is realized by a humanoid robot having a human-like appearance and being capable of recognizing emotions of the user.

The content owner apparatus 20 is an information processing apparatus used by a content owner. For example, the content owner apparatus 20 is an information processing apparatus such as a desktop-type personal computer (PC), a note-type PC, a tablet-type terminal, a smartphone, a mobile phone, or a personal digital assistant (PDA). The content owner apparatus 20 submits the content to the delivery apparatus 100 in accordance with operation by the content owner. For example, the content owner apparatus 20 submits a banner of a product sold by the content owner to the delivery apparatus 100 as the content. To give an example, the content owner apparatus 20 submits a still image, a moving image, text data and so on associated with the product to the delivery apparatus 100 as the banner of the product. A URL of a page where the content owner sells the content is incorporated into the banner of the product.

Meanwhile, there is a case where the content owner asks an agency to submit the content. In this case, the agency is supposed to submit the content to the delivery apparatus 100. Hereinafter, it is assumed that the expression of “content owner” represents a concept implying not only the content owner but also the agency and the expression of “content owner apparatus” represents a concept implying not only the content owner apparatus 20 but also an agency apparatus used by the agency.

The information provision apparatus 30 is a web server or the like that delivers the web page to the terminal apparatus 50. For example, the information provision apparatus 30 delivers various types of web pages regarding the EC site, a news site, an auction site, a weather forecast site, a shopping site, a finance (stock price) site, a route search site, a map service site, a travel site, a restaurant review site, a web blog, and the like.

The web page delivered by the information provision apparatus 30 is formed using, for example, an HTML file described by a HyperText markup language (HTML) or an XML file described by an extensible markup language (XML). Additionally, the web page delivered by the information provision apparatus 30 includes control information to control a display form of the web page or the content. This control information is described in the HTML file or the like forming the web page by using a script language such as JavaScript (registered trademark) or cascading style sheets (CSS).

The web page delivered by the information provision apparatus 30 also includes a content acquisition command. For example, a URL or the like of the delivery apparatus 100 is described in the HTML file or the like forming the web page as the content acquisition command. In this case, the terminal apparatus 50 accesses the URL described in the HTML file or the like to acquire the content from the delivery apparatus 100.

The terminal apparatus 50 is an information processing apparatus such as a desktop-type PC, a note-type PC, a tablet-type terminal, a smartphone, a mobile phone, or a personal digital assistant (PDA). The terminal apparatus 50 is used by the user who browses the web page. Specifically, the terminal apparatus 50 receives the web page from the information provision apparatus 30 in accordance with operation by the user and then displays the received web page on the screen. In a case where the content acquisition command described later is included in the web page, the terminal apparatus 50 also receives the content from the delivery apparatus 100 and then displays the received content on the screen.

The delivery apparatus 100 is a server apparatus that delivers the content. Specifically, the delivery apparatus 100 delivers the content submitted from the content owner apparatus 20. For example, upon receiving the content acquisition request, the delivery apparatus 100 delivers the content to a transmission source of this content acquisition request. To give an example, the delivery apparatus 100 delivers, to the terminal apparatus 50, the banner of a product sold by the content owner, which has been submitted by the content owner serving as a submitter.

### 1-3. Configuration of Delivery Apparatus According to First Embodiment

Next, a configuration of the delivery apparatus 100 according to the first embodiment will be described with reference to FIG. 3. FIG. 3 is a diagram illustrating an exemplary configuration of the delivery apparatus 100 according to the first embodiment. As illustrated in FIG. 3, the delivery apparatus 100 includes a communication unit 110, a storage unit 120, and a controller 130. The delivery apparatus 100 may include an input unit (e.g., a keyboard or a mouse) that accepts various types of operation from an administrator or the like using the delivery apparatus 100 and a display unit (e.g., a liquid crystal display) for displaying various types of information.

About Communication Unit 110

For example, the communication unit 110 is realized by a network interface card (NIC). Specifically, the communication unit 110 is connected to the network N in a wired or wireless manner and transmits/receives information to/from the artifact 10, the content owner apparatus 20, and the terminal apparatus 50 via the network N. For example, the communication unit 110 transmits/receives various types of acquisition requests, content and so on to/from the artifact 10, the content owner apparatus 20, and the terminal apparatus 50.

About Storage Unit 120

The storage unit 120 is realized by, for example, a semiconductor memory element such as a random access memory (RAM) or a flash memory, or alternatively, a storage apparatus such as a hard disk or an optical disc. The storage unit 120 includes a user information storage unit 121, a detection information storage unit 122, and a content information storage unit 123.

About User Information Storage Unit 121

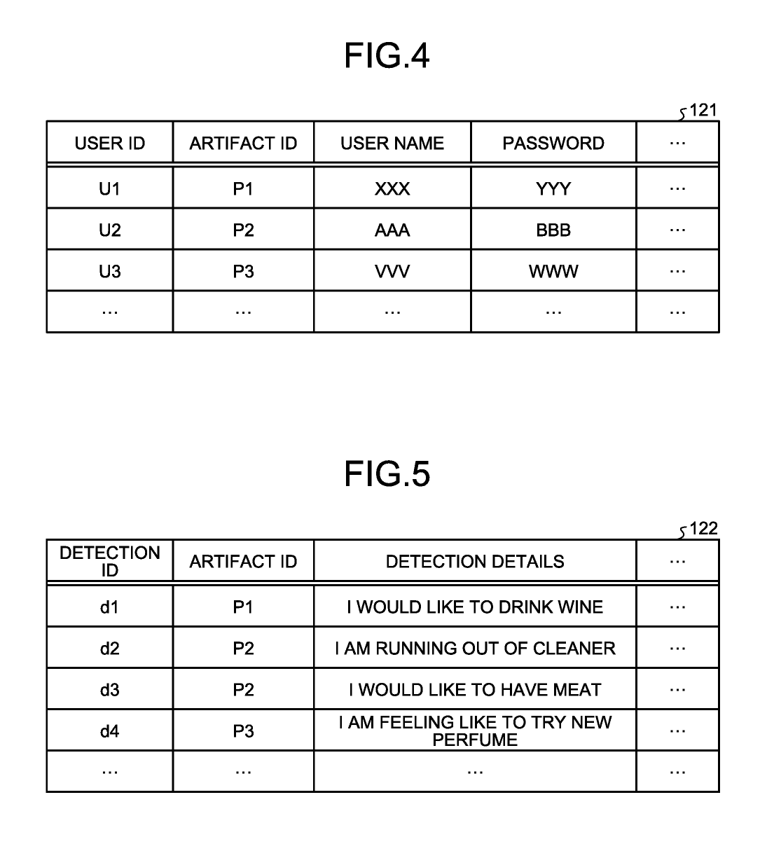

The user information storage unit 121 stores information regarding the user. Specifically, the user information storage unit 121 stores information regarding the artifact 10 owned by the user and information specific to the user for each of the users. Here, FIG. 4 illustrates an example of the user information storage unit 121 according to the first embodiment. As illustrated in FIG. 4, the user information storage unit 121 has items such as “user ID”, “artifact ID”, “user name”, and “password”.

“User ID” represents identification information for identifying the user. For example, “user ID” stores a unique character string consisting of alphanumeric characters and so on to individually assign to each of the users. To give an example, “user ID” is used when the user logs in the EC site. “Artifact ID” represents identification information for identifying the artifact 10. For example, “artifact ID” associates a unique character string consisting of alphanumeric characters and so on to be individually assigned to each of the artifacts 10 with the user ID corresponding to the user owing the artifact 10 to store. “User name” represents a name of the user. For example, “user name” stores a nickname set by the user for use in the Internet. “Password” represents a character string or the like used during the login to a site. For example, “password” stores a character string set by the user for use in the Internet. To give an example, “password” is used as a pair with the user ID when the user logs in the EC site.

That is, FIG. 4 illustrates an example where the user U1 identified by the user ID “U1” owns the artifact 10 identified by the artifact ID “P1”. This example also indicates that the user U1 identified by the user ID “U1” has the user name “XXX” and the password “YYY”.

About Detection Information Storage Unit 122

The detection information storage unit 122 stores information detected by the artifact 10. Specifically, the detection information storage unit 122 stores details of the information detected by the artifact 10 every time the artifact 10 carries out the detection. Here, FIG. 5 illustrates an example of the detection information storage unit 122 according to the first embodiment. As illustrated in FIG. 5, the detection information storage unit 122 has items such as “detection ID”, “artifact ID”, and “detection details”.

“Detection ID” represents identification information for identifying the detection information detected by the artifact 10. For example, “detection ID” stores a unique character string consisting of alphanumeric characters and so on to individually assign to each piece of the detection information. “Artifact ID” represents identification information for identifying the artifact 10 that has carried out the detection. For example, “artifact ID” associates a unique character string consisting of alphanumeric characters and so on to be individually assigned to each of the artifacts 10 with the detection ID corresponding to the detection information detected by the artifact 10 to store. “Detection details” represent details of the detection information detected by the artifact 10. For example, “detection details” store, as the detection information, a talk between the user and the artifact 10 or information regarding an environment where the artifact 10 is installed. To give an example, various types of the detection information, including a sound, a distance, an impact, a temperature, humidity, an odor, and brightness are stored in “detection details”.

That is, FIG. 5 illustrates an example where detection information d1 identified by the detection ID “d1” has been detected by the artifact 10 identified by the artifact ID “P1”. This example also indicates that the detection details of the detection information d1 identified by the detection ID “d1” are a spoken statement of “I would like to drink wine”.

About Content Information Storage Unit 123

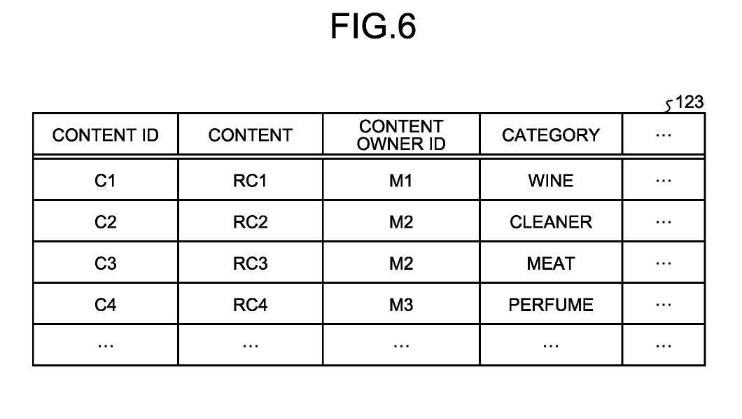

The content information storage unit 123 stores information regarding the content to be delivered to the user. Specifically, the content information storage unit 123 stores information regarding the content owner, a category and so on for each piece of the content. Here, FIG. 6 illustrates an example of the content information storage unit 123 according to the first embodiment. As illustrated in FIG. 6, the content information storage unit 123 has items such as “content ID”, “content”, “content owner ID”, and “category”.

“Content ID” represents identification information for identifying the content. For example, “content ID” stores a unique character string consisting of alphanumeric characters and so on to individually assign to each piece of the content. “Content” represents the content submitted from the content owner apparatus 20. FIG. 6 has illustrated an example where conceptual information such as “RC1” is saved in “content”. Actually, however, a still image, a moving image, text data, or a URL, or alternatively, a file path name or the like indicating a save location thereof is saved therein. For example, “content” stores the recommendation information to be recommended to the user as the content. To give an example, the banner of a product sold by the content owner, which has been submitted by the content owner, is stored in “content” as the recommendation information. “Content owner ID” represents identification information for identifying the content owner or the content owner apparatus 20. For example, a unique character string consisting of alphanumeric characters and so on to be individually given to each of the content owners is stored in “content owner ID” as the identification information. “Category” represents a classification of the content. For example, “category” stores a character string or the like indicating a classification to which the content belongs.

That is, FIG. 6 illustrates an example where the content “RC1” identified by the content ID “C1” has been submitted by a content owner identified by the content owner ID “M1”. This example in FIG. 6 also indicates that the content “RC1” identified by the content ID “C1” belongs to a category of “wine”.

About Controller 130

The description will continue by referring back to FIG. 3. For example, the controller 130 is realized by a central processing unit (CPU) or a micro processing unit (MPU) that executes various programs (corresponding to an example of the purchase support program) stored in a storage apparatus within the delivery apparatus 100 by using a RAM as a working area. As an alternative example, the controller 130 is realized by an application specific integrated circuit (ASIC), a field programmable gate array (FPGA), or another integrated circuit.

As illustrated in FIG. 3, the controller 130 includes an acquisition unit 131, a saving unit 132, a determination unit 133, and a delivery unit 134 and realizes or carries out a function or an action for the information processing described below. An internal configuration of the controller 130 is not limited to the configuration illustrated in FIG. 3 and another configuration may be employed as long as the configuration carries out the recommendation processing described later. The connection relationship among the respective processors included in the delivery apparatus 100 is not limited to the connection relationship illustrated in FIG. 3 and another connection relationship may be employed.

About Acquisition Unit 131

The acquisition unit 131 acquires the detection information detected by the artifact 10 that performs the conversational interaction with the user. Specifically, the acquisition unit 131 acquires, as the detection information, a talk between the user and the artifact 10 or environmental information regarding an environment where the artifact 10 is installed. For example, the acquisition unit 131 acquires the subject matter of the spoken statement by the user as the talk between the user and the artifact 10. To give an example, the acquisition unit 131 acquires a characteristic keyword relating to a product sold by the content owner from among the subject matters of the spoken statements by the user. To give another example, the acquisition unit 131 acquires information regarding a color, a shape, a temperature, humidity, a sound, or an odor detected by the artifact 10 as the environmental information. According to an example, the acquisition unit 131 acquires a color or a shape of an object present in a room where the artifact 10 is installed, humidity, a temperature, an odor, or brightness of the room, a sound emitting from various apparatuses installed in the room such as a television and a radio, and so on. The acquisition unit 131 according to one form acquires, from the detection information storage unit 122, the detection details stored by being associated with the artifact ID of the artifact 10 owned by the user corresponding to the terminal apparatus 50 serving as a transmission source of the acquisition request for the recommendation information.

About Saving Unit 132

The saving unit 132 saves the detection information. Specifically, the saving unit 132 saves the detection information acquired by the acquisition unit 131 to the detection information storage unit 122. For example, when the acquisition unit 131 acquires the detection information, the saving unit 132 gives the detection ID to the detection information and associates the artifact ID indicating the artifact 10 that has acquired the detection information and the detection details represented by the detection information with the detection ID to save to the detection information storage unit 122.

About Determination Unit 133

The determination unit 133 determines the content to be delivered to the terminal apparatus 50. In more specific terms, the determination unit 133 determines the content on the basis of the detection information acquired by the acquisition unit 131. Specifically, the determination unit 133 determines the recommendation information regarding a recommended product, which recommendation information is to be displayed in the EC site, on the basis of the detection information. For example, the determination unit 133 determines the recommendation information on the basis of the keyword in the detection details represented by the detection information and the category of the content stored in the content information storage unit 123. To give an example, the determination unit 133 determines, as the recommendation information, the content corresponding to the category to which the keyword in the detection details belongs, from among pieces of the content stored in the content information storage unit 123. The determination unit 133 according to one form determines, as the recommendation information, the content corresponding to the category to which the keyword belongs, which keyword is stored in the detection information storage unit 122 and frequently used in the detection details corresponding to the user. For example, the determination unit 133 determines, as the recommendation information, the banner of a product corresponding to food or drink consumed by the user at a high rate. In another example, the determination unit 133 determines, as the recommendation information, the banner of a product having a most used color among colors of the objects detected by the artifact 10. In another example, the determination unit 133 determines, as the recommendation information, the banner of a product having a most used shape among shapes of the objects detected by the artifact 10. In another example, the determination unit 133 determines, as the recommendation information, the banner of a product regarding cooling when the temperature detected by the artifact 10 is high, while determining the banner of a product regarding heating when the temperature is low. In another example, the determination unit 133 determines, as the recommendation information, the banner of a product regarding dehumidification when the humidity detected by the artifact 10 is high, while determining the banner of a product regarding humidification when the humidity is low. In another example, the determination unit 133 determines, as the recommendation information, the banner of a product having a most frequently observed odor among odors detected by the artifact 10. In another example, the determination unit 133 determines, as the recommendation information, the banner of a product regarding illumination when the brightness detected by the artifact 10 is low.

About Delivery Unit 134

On the basis of the detection information acquired by the acquisition unit 131, the delivery unit 134 delivers the recommendation information regarding a recommended product, which recommendation information is to be displayed in the EC site. Specifically, the delivery unit 134 delivers the recommendation information determined by the determination unit 133 to the terminal apparatus 50. For example, the delivery unit 134 delivers the recommendation information on the basis of the keyword in the detection details represented by the detection information and the category of the content stored in the content information storage unit 123. To give an example, the delivery unit 134 delivers, as the recommendation information, the content corresponding to the category to which the keyword in the detection details belongs, from among pieces of the content stored in the content information storage unit 123. The delivery unit 134 according to one form delivers the banner of a product, into which a URL of a page where the content owner sells the content is incorporated, as the recommendation information.

### 1-4. Recommendation Processing Procedures According to First Embodiment

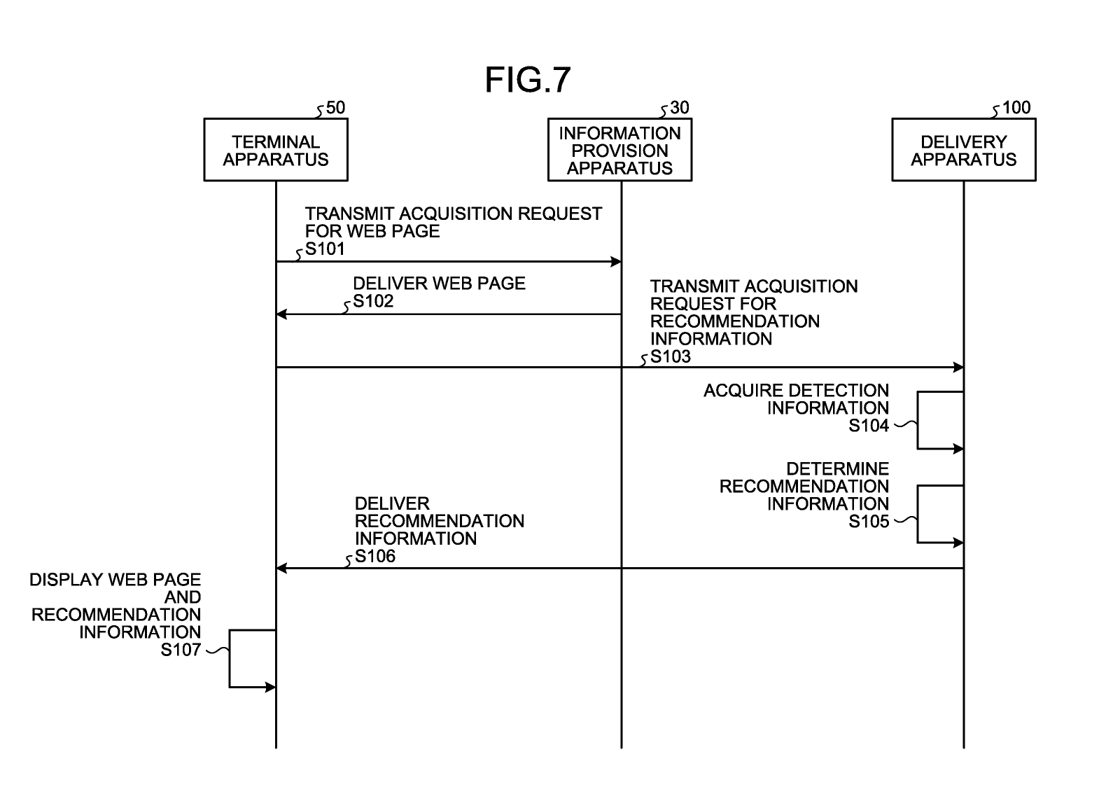

Next, procedures of the processing by the purchase support system 1 according to the first embodiment will be described with reference to FIG. 7. FIG. 7 is a sequence illustrating the recommendation processing procedures by the purchase support system 1 according to the first embodiment.

As illustrated in FIG. 7, the terminal apparatus 50 transmits the acquisition request for the web page to the information provision apparatus 30 in accordance with user operation (step S101). With this, the information provision apparatus 30 receives the acquisition request for the web page from the terminal apparatus 50.

Then, the information provision apparatus 30 delivers the web page to the terminal apparatus 50 in response to the acquisition request for the web page (step S102). The web page delivered by the information provision apparatus 30 includes a recommendation information acquisition command which is, for example, the URL of the delivery apparatus 100. With this, the terminal apparatus 50 acquires the web page from the information provision apparatus 30.

Subsequently, the terminal apparatus 50 transmits the acquisition request for the recommendation information to the delivery apparatus 100 on the basis of the recommendation information acquisition command included in the web page (step S103). With this, the delivery apparatus 100 receives the acquisition request for the recommendation information from the terminal apparatus 50.

Then, the delivery apparatus 100 acquires the detection information detected by the artifact 10 that performs the conversational interaction with the user (step S104). Specifically, as the detection information, the delivery apparatus 100 acquires, from the detection information storage unit 122, a talk between the user and the artifact 10 or the environmental information regarding an environment where the artifact 10 is installed. For example, the delivery apparatus 100 acquires the detection details stored by being associated with the artifact ID of the artifact 10 owned by the user corresponding to the terminal apparatus 50 serving as a transmission source of the acquisition request for the recommendation information.

Subsequently, the delivery apparatus 100 determines the recommendation information to be delivered to the user in response to the acquisition request for the recommendation information (step S105). Specifically, the delivery apparatus 100 determines the recommendation information regarding a recommended product, which recommendation information is to be displayed in the EC site, on the basis of the detection information. For example, the delivery apparatus 100 determines, as the recommendation information, the content corresponding to the category to which the keyword in the detection details represented by the detection information belongs, from among pieces of the content stored in the content information storage unit 123.

Then, the delivery apparatus 100 delivers the recommendation information (step S106). For example, the delivery apparatus 100 delivers the recommendation information regarding a recommended product, which recommendation information is to be displayed in the EC site, on the basis of the detection information. To give an example, the delivery apparatus 100 delivers, as the recommendation information, the content corresponding to the category to which the keyword in the detection details belongs, from among pieces of the content stored in the content information storage unit 123.

With this, the terminal apparatus 50 receives the recommendation information from the delivery apparatus 100. Then, the terminal apparatus 50 displays the web page and the recommendation information that have been received (step S107). For example, the terminal apparatus 50 displays, on the screen, the web page on which the received recommendation information is displayed.

### 1-5. Effects of First Embodiment

As described thus far, the purchase support system 1 according to the first embodiment includes the acquisition unit 131 and the delivery unit 134. The acquisition unit 131 acquires the detection information detected by the artifact 10 that performs the conversational interaction with the user. Meanwhile, on the basis of the acquired detection information, the delivery unit 134 delivers the recommendation information regarding a recommended product, which recommendation information is to be displayed in the EC site.

As a consequence, the purchase support system 1 can deliver the recommendation information based on the information detected by the artifact 10, thereby being able to support the purchase of a product. For example, the purchase support system 1 can recommend a product on the basis of the subject matter of a talk by the user and thus can recommend a product suitable for the user. In addition, because the purchase support system 1 can recommend a product based on the subject matter of a talk by the user while the user is browsing the EC site, a possibility of the user buying a product can be enhanced. Meanwhile, the purchase support system 1 makes a recommendation in the EC site and accordingly, reduction of willingness to purchase can be deterred compared to a recommendation made during a direct conversation with the artifact 10. Furthermore, sales promotion can be continuously performed since the purchase support system 1 makes a recommendation in the EC site.

Additionally, in the purchase support system 1 according to the first embodiment, the acquisition unit 131 acquires, as the detection information, a talk between the user and the artifact 10 or the environmental information regarding an environment where the artifact 10 is installed.

As a consequence, the purchase support system 1 can deliver the recommendation information based on the talk by the user or the environment thereof, thereby being able to deliver the recommendation information suitable for the user. Accordingly, for example, the purchase support system 1 can enhance a conversion rate of the recommendation information and thus can enhance a profit of the content owner.

Besides, in the purchase support system 1 according to the first embodiment, the acquisition unit 131 acquires, as the environmental information, information regarding a color, a shape, a temperature, humidity, a sound, or an odor detected by the artifact 10.

As a consequence, the purchase support system 1 can deliver the recommendation information based on the environment relating to the user, thereby being able to deliver the recommendation information suitable for the user. Accordingly, for example, the purchase support system 1 can enhance the conversion rate of the recommendation information and thus can enhance a profit of the content owner.

### 1-6. Variations

The purchase support system 1 according to the above-described first embodiment can be also carried out in various types of different modes other than the aforementioned first embodiment. Accordingly, other embodiments of the aforementioned purchase support system 1 will be described hereinafter.

### 1-6-1. Recommendation with Feedback Given on Top Thereof

The description of the aforementioned first embodiment has given an example where, on the basis of the detection information acquired by the acquisition unit 131, the delivery apparatus 100 delivers the recommendation information regarding a recommended product, which recommendation information is to be displayed in the EC site. Here, the delivery apparatus 100 may deliver the recommendation information by giving feedback about the recommendation information on top thereof.

Specifically, the delivery unit 134 of the delivery apparatus 100 delivers the recommendation information based on a result about the purchase of a product corresponding to the recommendation information by the user. For example, the delivery apparatus 100 gives feedback about whether the user has bought a product corresponding to the recommendation information on top thereof and thereafter, delivers this recommendation information to the user. To give an example, the delivery apparatus 100, when delivering, puts a priority on the recommendation information corresponding to a product belonging to the same category as that of a product that the user bought in the past. In another example, the delivery apparatus 100 gives feedback about whether the user has browsed information regarding a product corresponding to the recommendation information on top thereof and thereafter, delivers this recommendation information to the user. To give an example, the delivery apparatus 100, when delivering, puts a priority on the recommendation information corresponding to a product that the user has not bought but only browsed in the past.

As described above, the delivery apparatus 100 according to the variation delivers the recommendation information based on a result about the purchase of a product corresponding to the recommendation information by the user. As a consequence, the delivery apparatus 100 can deliver the recommendation information more suitable for the user, thereby being able to support the purchase of a product.

Meanwhile, the delivery apparatus 100 may update the recommendation information by confirming the necessity of a product corresponding to the recommendation information on the basis of a result about the purchase of this product by the user. For example, in a case where the user has not bought a product corresponding to the recommendation information, the delivery apparatus 100 transmits, to the artifact 10, instruction information for causing the artifact 10 to confirm the necessity of this product with the user. With this, the artifact 10 receives this instruction information from the delivery apparatus 100. Then, upon receiving this instruction information, the artifact 10 confirms the necessity of this product with the user and detects a confirmation result indicating the necessity of the product. Subsequently, the artifact 10 transmits the detected confirmation result to the delivery apparatus 100. With this, the delivery apparatus 100 receives the confirmation result indicating the necessity of the product from the artifact 10. Thereafter, the delivery apparatus 100 updates the recommendation information on the basis of the confirmation result indicating the necessity of the product. To give an example, when the confirmation result indicates that the product has the necessity, the delivery apparatus 100 delivers information regarding this product as the recommendation information. On the other hand, when the confirmation result indicates that the product does not have the necessity, the delivery apparatus 100 removes information regarding this product from the recommendation information. As a consequence, the delivery apparatus 100 can deliver the recommendation information after more accurately confirming the necessity of the product, thereby being able to enhance the precision of the recommendation suitable for the user. Besides, in addition to a case where the user has not bought a product corresponding to the recommendation information, also in a case where the user has bought a product, the delivery apparatus 100 may update the recommendation information by causing the artifact 10 to confirm whether the user further requires this product. As a consequence, the delivery apparatus 100 can enhance a repeat purchase rate of the same product by the user, thereby being able to enhance sales of the product.

### 1-6-2. Forms of Recommendation

The description of the aforementioned first embodiment has given an example where the delivery apparatus 100 delivers, to the terminal apparatus 50, the recommendation information to be displayed on the web page of the EC site for displaying product recommendations. Here, the delivery apparatus 100 may make a recommendation in accordance with various types of forms.

Specifically, the delivery unit 134 of the delivery apparatus 100 delivers the recommendation information to be displayed at a timing or through a method arbitrarily set by the site or the user. For example, the delivery apparatus 100 delivers the recommendation information to be displayed as a list in the EC site at a timing when the user logs in the EC site. In another example, the delivery apparatus 100 delivers the recommendation information in accordance with a form for displaying a recommendation mark on a product corresponding to the recommendation information. Meanwhile, in another example, the delivery apparatus 100 may deliver the recommendation information based on the detection information detected by another artifact 10 owned by another user in addition to the user owing the artifact 10. In addition, in another example, the delivery apparatus 100 may deliver the recommendation information based on a vacant storage space detected by the artifact 10. For example, the delivery apparatus 100 delivers the recommendation information regarding a product having a size that can fit in the vacant storage space detected by the artifact 10. Furthermore, in another example, the delivery apparatus 100 may deliver the recommendation information based on a book detected by the artifact 10. For example, the delivery apparatus 100 delivers the recommendation information regarding a book in the same genre or by the same author as that of the book detected by the artifact 10. Additionally, in another example, the delivery apparatus 100 may deliver the recommendation information in response to a result of face recognition detected by the artifact 10. In still another example, the delivery apparatus 100 may exclude a thing that the user does not like or is not a user's favorite one when delivering the recommendation information on a product.

As described above, the delivery apparatus 100 according to the variation makes a recommendation in accordance with the various types of forms. As a consequence, the delivery apparatus 100 can display the recommendation information through an approach likely to catch the user's attention, thereby being able to support the purchase of a product.

### 1-6-3. Effects of Variations

As described thus far, in the purchase support system 1 according to the variation, the delivery unit 134 delivers the recommendation information based on a result about the purchase of a product corresponding to the recommendation information by the user. As a consequence, the purchase support system 1 can deliver the recommendation information more suitable for the user, thereby being able to support the purchase of a product.

### 2. Second Embodiment

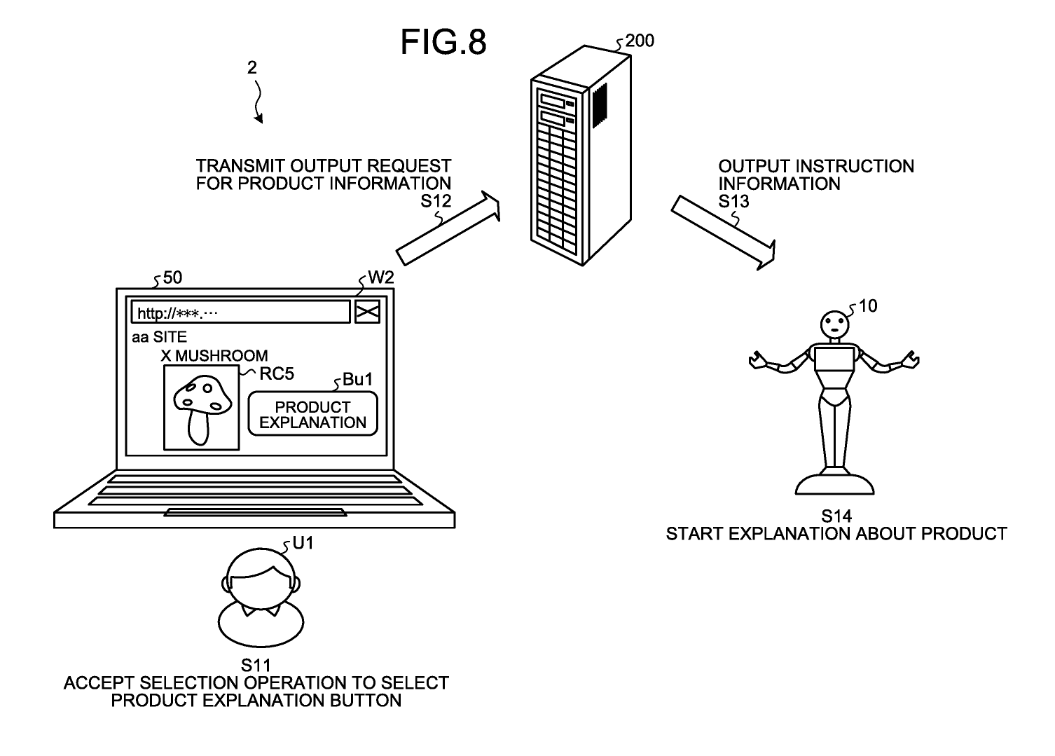

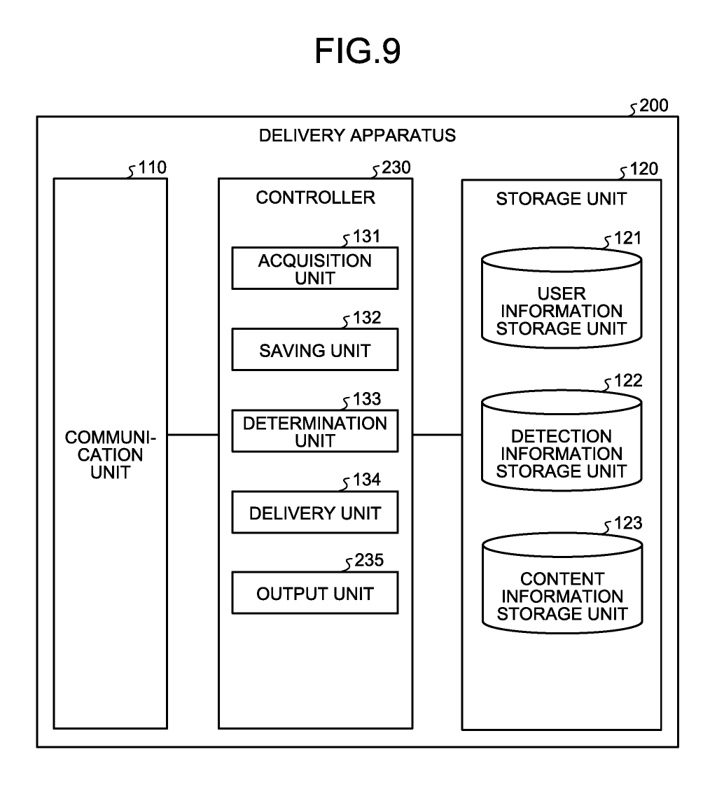

The aforementioned first embodiment has described a case where the purchase support system 1 recommends a product to the user in the EC site on the basis of the detection information detected by the artifact 10. However, embodiments are not limited thereto. Specifically, in the purchase support system 1, the artifact 10 may explain a product. This point will be described in detail with reference to FIG. 8 and FIG. 9. Note that a function unit that demonstrates a function similar to that in the aforementioned first embodiment will be denoted with the same reference numeral and the description thereof will be omitted.

### 2-1. Explanation Processing According to Second Embodiment

First, an example of explanation processing according to a second embodiment will be described with reference to FIG. 8. FIG. 8 is an explanatory diagram illustrating an example of the explanation processing by a purchase support system 2 according to the second embodiment. In the example in FIG. 8, the explanation processing is carried out in which an artifact 10 gives an explanation of a product selected by a user U1.

As illustrated in FIG. 8, the purchase support system 2 includes the artifact 10, a terminal apparatus 50, and a delivery apparatus 200. When compared to the delivery apparatus 100, the delivery apparatus 200 is a server apparatus further having a function of outputting an instruction to the artifact 10.

Specifically, in the purchase support system 2, the terminal apparatus 50 first accepts, from the user U1, selection operation in which a product explanation button Bu1 displayed on a web page W2 regarding a product RC5 is selected (step S11).

Then, upon accepting the selection operation to select the product explanation button Bu1, the terminal apparatus 50 transmits an output request for product information regarding the product RC5 to the delivery apparatus 200 (step S12). With this, the delivery apparatus 200 receives the output request for the product information from the terminal apparatus 50.

Subsequently, upon receiving the output request for the product information regarding the product RC5 through the operation by the user U1, the delivery apparatus 200 outputs instruction information instructing the artifact 10 about an action relating to the product information (step S13). Specifically, as the instruction information, the delivery apparatus 200 outputs instruction information for causing the artifact 10 to explain the product RC5. With this, the artifact 10 receives the instruction information from the delivery apparatus 200.

Then, upon receiving the instruction information from the delivery apparatus 200, the artifact 10 starts the explanation about the product RC5 (step S14). For example, the artifact 10 explains about a size, a taste, a cooking recipe and so on of the product RC5 by using a screen provided in the artifact 10.

As described above, upon receiving the output request for the product information regarding a product through the operation by the user, the delivery apparatus 200 according to the second embodiment outputs the instruction information instructing the artifact 10 about an action relating to the product information.

As a consequence, the delivery apparatus 200 can explain the product to the user by using the artifact 10, thereby being able to support the purchase of the product. For example, the delivery apparatus 200 can communicate details of the product to the user in an easy way to understand and thus can enhance the conversion rate as to the user buying the product.

### 2-2. Configuration of Delivery Apparatus According to Second Embodiment

Next, a configuration of the delivery apparatus 200 according to the second embodiment will be described with reference to FIG. 9. FIG. 9 is a diagram illustrating an exemplary configuration of the delivery apparatus 200 according to the second embodiment. As illustrated in FIG. 9, the delivery apparatus 200 includes a controller 230 having a different function when compared to the delivery apparatus 100. Note that a function unit that demonstrates a function similar to that in the aforementioned first embodiment will be denoted with the same reference numeral and the description thereof will be omitted.

About Controller 230

The controller 230 further includes an output unit 235 when compared to the controller 130. Note that a function unit that demonstrates a function similar to that in the aforementioned first embodiment will be denoted with the same reference numeral and the description thereof will be omitted. In addition, an internal configuration of the controller 230 is not limited to the configuration illustrated in FIG. 9 and another configuration may be employed as long as the configuration carries out the explanation processing described later.

About Output Unit 235

Upon receiving the output request for the product information regarding a product through the operation by the user, the output unit 235 outputs the instruction information instructing the artifact 10 about an action relating to the product information. Specifically, the output unit 235 outputs, to the artifact 10, the instruction information that gives an instruction about an action in response to the operation on the EC site. Specifically, as the instruction information, the output unit 235 outputs instruction information for causing the artifact 10 to explain the product. To give an example, the output unit 235 outputs, as the instruction information, instruction information for causing the artifact 10 to explain the cooking recipe of food. The output unit 235 according to one form outputs instruction information for causing the artifact 10 to explain the cooking recipe of the product when a cooking explanation button for the product is selected by the user. In another example, the output unit 235 outputs, as the instruction information, instruction information for causing the artifact 10 to display or project information regarding the product. The output unit 235 according to one form outputs instruction information for displaying the information regarding the product on the screen provided in the artifact 10 or projecting the information onto a wall. For example, the output unit 235 outputs, to the artifact 10, instruction information for projecting clothing onto the user him/herself. In another example, the output unit 235 outputs, as the instruction information, instruction information for causing the artifact 10 to embody information regarding the product. The output unit 235 according to one form outputs instruction information for expressing the appearance of the product including a size or a shape thereof by using an arm provided in the artifact 10. In another example, the output unit 235 outputs, as the instruction information, instruction information for causing the artifact 10 to emit an odor of the product.

### 2-3. Explanation Processing Procedures According to Second Embodiment

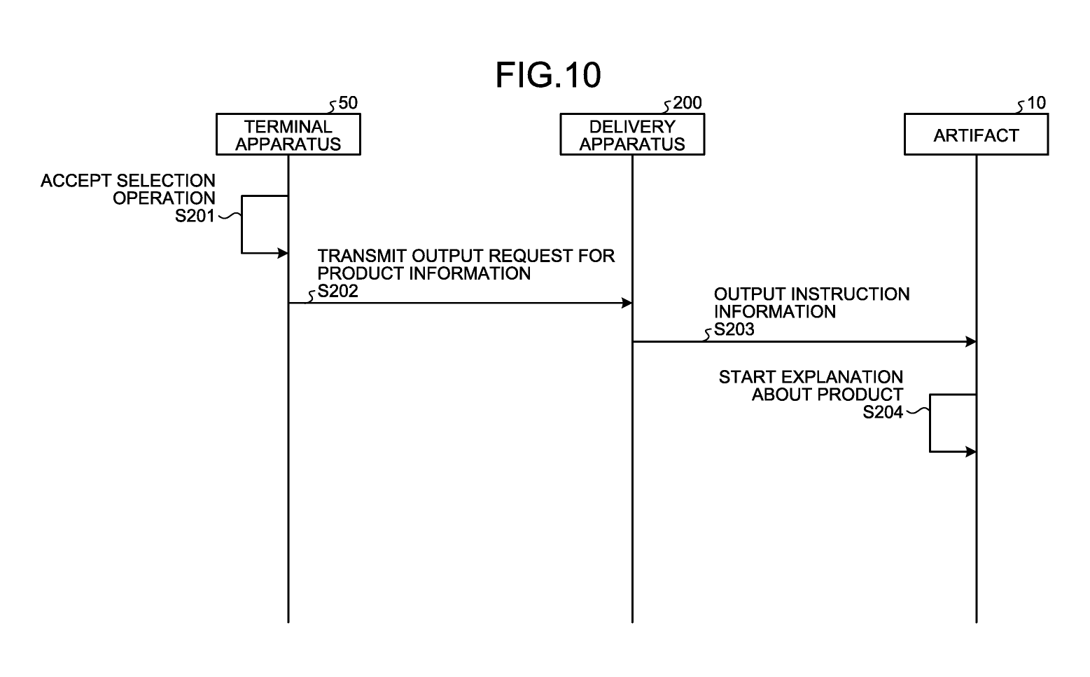

Next, procedures of the processing by the purchase support system 2 according to the second embodiment will be described with reference to FIG. 10. FIG. 10 is a sequence illustrating the explanation processing procedures by the purchase support system 2 according to the second embodiment.

As illustrated in FIG. 10, in the purchase support system 2, the terminal apparatus 50 first accepts the selection operation (step S201). For example, the terminal apparatus 50 accepts, from the user, operation of clicking the product explanation button displayed on the web page regarding a product.

Subsequently, upon accepting the selection operation, the terminal apparatus 50 transmits the output request for the product information regarding the product to the delivery apparatus 200 (step S202). For example, upon accepting the selection of the product explanation button from the user, the terminal apparatus 50 transmits the output request for the product information to the delivery apparatus 200. With this, the delivery apparatus 200 receives the output request for the product information from the terminal apparatus 50.

Thereafter, upon receiving the output request for the product information, the delivery apparatus 200 outputs the instruction information instructing the artifact 10 about an action relating to the product information (step S203). For example, the delivery apparatus 200 outputs, as the instruction information, instruction information for causing the artifact 10 to explain the product. With this, the artifact 10 receives the instruction information from the delivery apparatus 200.

Then, upon receiving the instruction information from the delivery apparatus 200, the artifact 10 starts the explanation about the product (step S204). For example, the artifact 10 explains about a size, a taste, a cooking recipe and so on of the product by using the screen provided in the artifact 10.

### 2-4. Effects of Second Embodiment

As described thus far, the delivery apparatus 200 according to the second embodiment further includes the output unit 235. Upon receiving the output request for the product information regarding a product through the operation by the user, the output unit 235 outputs the instruction information instructing the artifact 10 about an action relating to the product information.

As a consequence, the delivery apparatus 200 can explain the product to the user by using the artifact 10, thereby being able to support the purchase of the product. For example, the delivery apparatus 200 can communicate details of the product to the user in an easy way to understand and thus can enhance the conversion rate as to the user buying the product.

In addition, in the delivery apparatus 200 according to the second embodiment, the output unit 235 outputs, to the artifact 10, the instruction information that gives an instruction about an action in response to the operation on the EC site. As a consequence, the delivery apparatus 200 can cause the artifact 10 to act in response to the operation by the user, thereby being able to support the purchase by the user.

Meanwhile, in the delivery apparatus 200 according to the second embodiment, the output unit 235 outputs the instruction information for causing the artifact 10 to explain the product, as the instruction information. As a consequence, the delivery apparatus 200 can communicate the product to the user in an easy way to understand, thereby being able to support the purchase by the user.

Furthermore, in the delivery apparatus 200 according to the second embodiment, the output unit 235 outputs the instruction information for causing the artifact 10 to explain the cooking recipe of food, as the instruction information. As a consequence, the delivery apparatus 200 can communicate the cooking recipe of food to the user and thus can enhance the conversion rate as to the user buying the product.

Besides, in the delivery apparatus 200 according to the second embodiment, the output unit 235 outputs the instruction information for causing the artifact 10 to display or project information regarding the product, as the instruction information. As a consequence, the delivery apparatus 200 can visually explain the product, thereby being able to support the purchase by the user.

Additionally, in the delivery apparatus 200 according to the second embodiment, the output unit 235 outputs the instruction information for causing the artifact 10 to embody information regarding the product, as the instruction information. As a consequence, the delivery apparatus 200 can communicate the product to the user in an easy way to understand, thereby being able to support the purchase by the user.

### 2-5. Variations

The purchase support system 2 according to the above-described embodiment can be also carried out in various types of different modes other than the aforementioned embodiment. Accordingly, other embodiments of the aforementioned purchase support system 2 will be described hereinafter.

### 2-5-1. Alarm

The description of the aforementioned embodiment has given an example where, upon receiving the output request for the product information regarding a product through the operation by the user, the delivery apparatus 200 outputs the instruction information instructing the artifact 10 about an action relating to the product information. Here, the delivery apparatus 200 may give a warning when a predetermined condition is satisfied.

Specifically, when a product registered by the user as a product to be bought satisfies a predetermined condition, the output unit 235 of the delivery apparatus 200 outputs, as the instruction information, instruction information for causing the artifact 10 to issue a warning. To give an example of the predetermined condition, when the terminal apparatus 50 accepts operation to buy food to which the user has an allergy, the delivery apparatus 200 outputs instruction information for causing the artifact 10 to notify the user of attempting to buy an article that causes an allergic reaction, by using a sound or a movement of the body. Here, as for a substance to which the user has an allergy, for example, the terminal apparatus 50 or the delivery apparatus 200 holds information set in advance by the user. To give another example of the predetermined condition, when the terminal apparatus 50 accepts operation by the user to buy the same product again, the delivery apparatus 200 outputs instruction information for causing the artifact 10 to notify the user that the same product is picked up again, by using a sound or a movement of the body. Additionally, the delivery apparatus 200 may transmit instruction information for causing the terminal apparatus 50 to issue a warning through a pop-up screen or a sound in addition to the artifact 10.

As described above, when a product registered by the user as a product to be bought satisfies the predetermined condition, the delivery apparatus 200 according to the variation outputs the instruction information for causing the artifact 10 to issue a warning, as the instruction information. As a consequence, the delivery apparatus 200 can give a warning when something inconvenient for the user is attempted to be bought, thereby being able to support the purchase by the user.

### 2-5-2. Instruction Information

The description of the aforementioned embodiment has given an example where the delivery apparatus 200 outputs the instruction information for causing the artifact 10 to explain a product. Here, the delivery apparatus 200 may output various types of the instruction information in addition thereto.

For example, the output unit 235 of the delivery apparatus 200 outputs instruction information for giving the explanation about a product recommended to the user on the basis of the detection information detected by the artifact 10. In another example, the delivery apparatus 200 outputs instruction information for giving a demonstration of a product in a case before the user buys the product. On the other hand, in a case after the user buys the product, the delivery apparatus 200 outputs instruction information for giving a support of the product. In another example, the delivery apparatus 200 outputs instruction information for causing the artifact 10 to give an explanation selected by the user from among a plurality of explanations regarding the product displayed on the terminal apparatus 50 as a list.

As described above, the delivery apparatus 200 according to the variation outputs the various types of the instruction information. As a consequence, the delivery apparatus 200 can cause the artifact 10 to act variously, thereby being able to support the purchase by the user.

### 2-5-3. Apparatus Configuration

The description of the aforementioned embodiment has given an example where the delivery apparatus 200 further includes the output unit 235 when compared to the delivery apparatus 100. Here, the delivery apparatus 200 may not include function units such as the acquisition unit 131, the saving unit 132, and the determination unit 133. In different words, the delivery apparatus 200 may be an apparatus configured to carry out the explanation processing without carrying out the above-described recommendation processing.

### 2-5-4. Effects of Variations

As described thus far, the delivery apparatus 200 according to the variation includes the output unit 235. When a product registered by the user as a product to be bought satisfies the predetermined condition, the output unit 235 outputs the instruction information for causing the artifact 10 to issue a warning, as the instruction information. As a consequence, the delivery apparatus 200 can give a warning when something inconvenient for the user is attempted to be bought, thereby being able to support the purchase by the user.

### 3. Others

The description of the aforementioned embodiments has given examples where the delivery apparatuses 100 and 200 makes a recommendation and gives an explanation, respectively, for a product. Here, the delivery apparatuses 100 and 200 may treat a service as an object in addition to a product. As a consequence, the delivery apparatuses 100 and 200 can treat a service as an object in addition to a product, thereby being able to further support the purchase by the user.

Among various types of the processing described in the aforementioned embodiments, all or some of the processing described as being automatically carried out can be carried out manually, or reversely, all or some of the processing described as being manually carried out can be carried out automatically using a publicly available method. In addition to this, information indicated within this document and the drawings described above including processing procedures, specific names, and various types of data and parameters can be arbitrarily altered unless otherwise specially stated.

Each of the illustrated components of the respective apparatuses serves as a sort of a function concept and thus is not necessarily required to be physically configured as illustrated. In other words, specific modes of separation and integration of the respective apparatuses are not limited to the illustrated ones and accordingly, all or some thereof can be configured so as to be functionally and physically separated or integrated in any units depending on various types of loads, usage, and the like.

For example, the user information storage unit 121, the detection information storage unit 122, and the content information storage unit 123 illustrated in FIG. 3 may not be held by the delivery apparatus 100 but may be held by a storage server or the like. In this case, the delivery apparatus 100 accesses the storage server to acquire various types of the information.

Meanwhile, the delivery apparatus 100 may be a determination apparatus configured to solely carry out determination processing without carrying out delivery processing. In this case, the determination apparatus does not include the delivery unit 134. Accordingly, a delivery apparatus including the delivery unit 134 delivers the recommendation information.

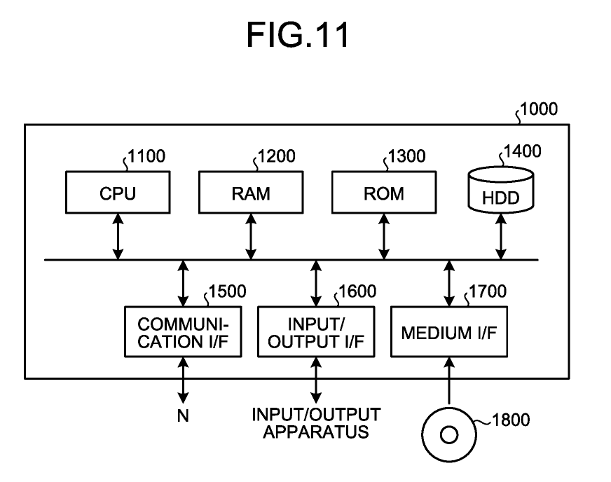

Furthermore, the delivery apparatus 100 according to the embodiment described thus far is realized by a computer 1000, for example, configured as illustrated in FIG. 11. The following description will use the delivery apparatus 100 as an example. FIG. 11 is a hardware configuration diagram illustrating an example of the computer 1000 that realizes a function of the delivery apparatus 100. The computer 1000 includes a CPU 1100, a RAM 1200, a ROM 1300, an HDD 1400, a communication interface (I/F) 1500, an input/output interface (I/F) 1600, and a medium interface (I/F) 1700.

The CPU 1100 works on the basis of a program saved in the ROM 1300 or the HDD 1400 to control respective constituent members. The RAM 1200 temporarily stores various types of information. A boot program executed by the CPU 1100 at the startup of the computer 1000, a program that depends on the hardware of the computer 1000, and the like are saved in the ROM 1300.

A program executed by the CPU 1100 along with data used by this program, and the like are saved in the HDD 1400. The communication interface 1500 receives data from another appliance via the network N to send to the CPU 1100 and transmits data generated by the CPU 1100 to another appliance via the network N.

The CPU 1100 controls output apparatuses such as a display and a printer and input apparatuses such as a keyboard and a mouse via the input/output interface 1600. The CPU 1100 acquires data from the input apparatus via the input/output interface 1600. In addition, the CPU 1100 outputs the generated data to the output apparatus via the input/output interface 1600.

The medium interface 1700 reads a program or data saved in a recording medium 1800 to provide to the CPU 1100 via the RAM 1200. The CPU 1100 loads this program to the RAM 1200 from the recording medium 1800 via the medium interface 1700 and executes the loaded program. Examples of the recording medium 1800 include an optical recording medium such as a digital versatile disk (DVD) and a phase change rewritable disk (PD), a magneto optical recording medium such as a magneto optical disk (MO), a tape medium, a magnetic recording medium, and a semiconductor memory.

For example, when the computer 1000 functions as the delivery apparatus 100 according to the embodiment, the CPU 1100 of the computer 1000 executes the program loaded on the RAM 1200, thereby realizing the function of the controller 130. Meanwhile, data within the storage unit 120 is saved in the HDD 1400. The CPU 1100 of the computer 1000 reads these programs from the recording medium 1800 to execute but in another example, these programs may be acquired from another apparatus via the network N.

Furthermore, the above-described delivery apparatus 100 may be realized by a plurality of server computers and the configuration thereof can be flexibly modified in such a manner that, for example, an external platform or the like is called through an application programming interface (API) or network computing when some functions are realized.

Additionally, “section”, “module” and “unit” described in claims can be read as “means”, “circuit”, and the like. For example, the acquisition unit can be read as an acquisition means and an acquisition circuit.

The above-described embodiment can be applied not only to a purchase support system, a purchase support method, and a purchase support program but also to a control apparatus for a man-machine interaction. The control apparatus for a man-machine interaction according to the present application includes a first processing unit (corresponding to the acquisition unit 131) that acquires detection information detected using a sensor as a receptor by an artifact including an interface configured to perform a man-machine conversational interaction with a user, using the sensor and an effector as an output apparatus, the detection information indicating a status of the interaction, and a second processing unit (corresponding to the delivery unit 134) that, based on the detection information acquired by the first processing unit, controls the interaction by an electronic information processing apparatus including a storage apparatus by controlling at least one of reading and writing from and to data stored in the storage apparatus and processing on the data and the output apparatus.

The control apparatus for a man-machine interaction can be applied not only to electronic commerce but also to other technical fields such as child care, education, nursing care, and security utilizing an artifact such as a robot. “The purchase support system that includes an acquisition unit that acquires detection information detected by an artifact configured to perform a conversational interaction with a user, and a delivery unit that delivers recommendation information regarding a recommended product, which recommendation information is to be displayed in an electronic commerce (EC) site, on the basis of the detection information acquired by the acquisition unit” can be performed alone without requiring a configuration “A control apparatus for a man-machine interaction that includes a first processing unit that acquires detection information detected using a sensor as a receptor by an artifact including an interface configured to perform a man-machine conversational interaction with a user, using the sensor and an effector as an output apparatus, the detection information indicating a status of the interaction, and a second processing unit that, based on the detection information acquired by the first processing unit, controls the interaction by an electronic information processing apparatus including a storage apparatus by controlling at least one of reading and writing from and to data stored in the storage apparatus and processing on the data and the output apparatus”.

According to an aspect of an embodiment, an effect that can support the purchase of a product is achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control apparatus for a man-machine interaction comprising:
a first processing unit that acquires detection information detected using a sensor as a receptor by an artifact including an interface configured to perform a man-machine conversational interaction with a user, using the sensor and an effector as an output apparatus, the detection information indicating a status of the interaction; and
a second processing unit that, based on the detection information acquired by the first processing unit, controls the interaction by an electronic information processing apparatus including a storage apparatus by controlling at least one of reading and writing from and to data stored in the storage apparatus and processing on the data and the output apparatus.

2. A purchase support system realized by the control apparatus for a man-machine interaction of claim 1, wherein
the purchase support system includes:
an acquisition unit that, as the first processing unit, acquires detection information detected by an artifact configured to perform a conversational interaction with a user; and
a delivery unit that, as the second processing unit, delivers recommendation information regarding a recommended product, which recommendation information is to be displayed in an electronic commerce (EC) site, on the basis of the detection information acquired by the acquisition unit.

3. The purchase support system according to claim 2, wherein
the acquisition unit acquires, as the detection information, a talk between the user and the artifact or environmental information regarding an environment where the artifact is installed.

4. The purchase support system according to claim 3, wherein
the acquisition unit acquires, as the environmental information, information regarding a color, a shape, a temperature, humidity, a sound, or an odor detected by the artifact.

5. The purchase support system according to claim 2, wherein
the delivery unit delivers the recommendation information based on a result about the purchase of a product corresponding to the recommendation information by the user.

6. The purchase support system according to claim 2, further comprising an output unit that, upon receiving an output request for product information regarding a product through operation by the user, outputs instruction information instructing the artifact about an action relating to the product information.

7. The purchase support system according to claim 6, wherein
the output unit outputs, to the artifact, the instruction information configured to give an instruction about an action in response to operation on the EC site.

8. The purchase support system according to claim 6, wherein
the output unit outputs, as the instruction information, instruction information configured to cause the artifact to explain the product.

9. The purchase support system according to claim 6, wherein
the output unit outputs, as the instruction information, instruction information configured to cause the artifact to explain a cooking recipe of food.

10. The purchase support system according to claim 6, wherein
the output unit outputs, as the instruction information, instruction information configured to cause the artifact to display or project information regarding the product.

11. The purchase support system according to claim 6, wherein
the output unit outputs, as the instruction information, instruction information configured to cause the artifact to embody information regarding the product.

12. The purchase support system according to claim 6, wherein
when a product registered by the user as a product to be bought satisfies a predetermined condition, the output unit outputs, as the instruction information, instruction information configured to cause the artifact to issue a warning.

13. A method performed by a computer, the method comprising:
an acquisition process that acquires detection information detected by an artifact configured to perform a conversational interaction with a user; and
a delivery process that delivers recommendation information regarding a recommended product, which recommendation information is to be displayed in an EC site, on the basis of the detection information acquired through the acquisition process.

14. A non-transitory computer readable storage medium having stored therein a computer program that causes a computer to carry out:
an acquisition procedure that acquires detection information detected by an artifact configured to perform a conversational interaction with a user; and
a delivery procedure that delivers recommendation information regarding a recommended product, which recommendation information is to be displayed in an EC site, on the basis of the detection information acquired through the acquisition procedure.
